(19) United States
(12) Patent Application Publication
(10) Pub. No.: US 2011/0129774 A1
(43) Pub. Date: Jun. 2, 2011

(54) INCORPORATION OF AN OIL COMPONENT INTO PHASE INVERSION EMULSION PROCESS

(75) Inventors: Valerie M. Farrugia, Oakville (CA); Kimberly D. Nosella, Mississauga (CA); Edward Graham Zwartz, Mississauga (CA); Barkev Keoshkerian, Thornhill (CA)

(73) Assignee: XEROX CORPORATION, Norwalk, CT (US)

(21) Appl. No.: 12/629,267

(22) Filed: Dec. 2, 2009

(51) Int. Cl. G03G 9/08; G03G 9/09

(52) U.S. Cl. 430/108.14; 430/108.2; 430/108.3; 430/108.4; 430/137.14

(57) ABSTRACT

A process for making a resin emulsion suitable for use in forming toner particles including an oil component incorporated into the latex core of the toner particles.

### TECHNICAL FIELD

The present disclosure relates to processes for producing resin emulsions useful in producing toners. More specifically, the present disclosure relates to energy efficient processes for eliminating wax dispersions in the phase inversion emulsification of polyester resins utilizing an oil component.

### BACKGROUND

Numerous processes are within the purview of those skilled in the art for the preparation of toners. Emulsion aggregation (EA) is one such method. Emulsion aggregation toners may be used in forming print and/or xerographic images. Emulsion aggregation techniques may involve the formation of an emulsion latex of the resin particles by heating the resin using a batch or semi-continuous emulsion polymerization, as disclosed in, for example, U.S. Pat. No. 5,853,943, the disclosure of which is hereby incorporated by reference in its entirety. Other examples of emulsion/aggregation/coalescing processes for the preparation of toners are illustrated in U.S. Pat. Nos. 5,902,710; 5,910,387; 5,916,725; 5,919,595; 5,925,488, 5,977,210, 5,994,020, and U.S. Patent Application Publication No. 2008/01017989, the disclosures of each of which are hereby incorporated by reference in their entirety.

Polyester EA ultra low melt (ULM) toners have been prepared utilizing amorphous and crystalline polyester resins as illustrated, for example, in U.S. Patent Application Publication No. 2008/0153027, the disclosure of which is hereby incorporated by reference in its entirety. The incorporation of these polyesters into the toner generally requires that they first be formulated into latex emulsions prepared by solvent containing batch processes, for example solvent flash emulsification and/or solvent-based phase inversion emulsification (PIE).

Conventionally, waxes are utilized in toner formulations in order to aid in toner release from the fuser roll during fusing, particularly in oil less fuser designs, and to help release the fused image document from the fuser roll, that is, to prevent the fused image document from curling around the fuser roll. Furthermore, waxes aid in the prevention of document offset, which may occur where fused images on documents in contact over a prolonged period of time or at elevated temperatures become transferred from one document to another (toner-to-toner and toner-to-paper). In fuser designs that utilize stripper fingers to aid in the removal of the fused image document from the fuser roll, waxes are added to toner formulations in order to reduce the occurrence of stripper finger marks on the fused images (scratch marks, changes in image gloss, and the like). A low-oil fuser system may thus alleviate issues such as caused by toner-fuser oil interactions, oil contamination, and the like. However, for a low-oil fuser to function, it is necessary to include wax in the toner formulation.

Polyethylene waxes are conventionally utilized in polyester EA toner designs where high gloss is a requirement. Such waxes may be in the form of an aqueous emulsion or dispersion of solid wax in water, where the solid wax particle size is usually from about 100 to about 500 nm. The wax particles in the emulsions need to be stabilized and require high heat and pressure during homogenization to achieve smaller wax particles. Processes for producing wax emulsions wherein surfactants are used as stabilizers are known, including those disclosed in U.S. Patent Application Publication No. 2008/0085460, the disclosure of which is hereby incorporated by reference in its entirety. Processes for producing wax emulsions wherein surfactants are not utilized are also known, including those disclosed in U.S. Patent Application Publication No. 2008/0090163, wherein the wax component is dissolved with the polyester resin in a solvent during a solvent flash emulsification step. With the above processes, it is necessary to ensure that the wax component is retained in the toner during the EA process.

Accordingly, improved processes for the preparation of polyester dispersions suitable for use in a toner are desirable.

### SUMMARY

A process of the present disclosure includes the steps of contacting at least one polyester resin with an organic solvent and a phase inversion agent to form a resin mixture; adding at least one oil component to the resin mixture; heating the resin mixture to a temperature of from about 25° C. to about 120° C.; neutralizing the resin mixture with a neutralizing agent; and introducing de-ionized water to the resin mixture to form a resin emulsion.

In another aspect, a process is provided which includes contacting at least one polyester resin possessing acid groups with an organic solvent and a phase inversion agent to form a mixture; adding jojoba oil to the mixture; heating the mixture to a temperature of from about 25° C. to about 120° C.; adding an aqueous solution comprising a neutralizing agent to the mixture; introducing de-ionized water to the mixture until phase inversion occurs to form a phase inversed mixture; removing the solvents from the phase inversed mixture; and recovering resin particles, wherein the oil component is incorporated in a hydrophobic core of the resin particles.

A toner of the present disclosure includes at least one polyester resin comprising resin particles; at least one oil component; and an optional colorant with optional toner additives, wherein the at least one oil component forms a hydrophobic core of the resin particles.

### BRIEF DESCRIPTION OF DRAWINGS

Various embodiments of the present disclosure will be described herein below with reference to the figures wherein:

FIG. 1 is a schematic process in accordance with the present disclosure;

FIG. 2 is a graph depicting particle size measurements taken and run in a Multisizer Coulter counter in accordance with Example 2 of the present disclosure;

FIG. 3 is a graph depicting gloss values obtained for toners of the present disclosure compared with a conventional control toner; and

FIG. 4 is a graph depicting crease performance values obtained for toners of the present disclosure compared with a conventional control toner.

### DETAILED DESCRIPTION

Previous disclosures cited above describe processes for making a polyester dispersion with PIE. However, the production of these dispersions by PIE, with an oil component incorporated into the polyester resin and solvent mixture have not been explored. In accordance with the present disclosure, processes are provided requiring reduced amounts of surfactant and solvent, without the use of high pressure and heat homogenization for wax emulsification, which will aid in toner release from the fuser roll during fusing and prevent document offset.

As noted above, the present disclosure discloses a method for preparing a phase inversion emulsion containing an oil component, sometimes also referred to herein as a hydrocarbon component, for a more efficient solvent-based phase inversion emulsification of polyesters. In embodiments, the present disclosure discloses a toner composition, wherein the toner includes an oil component for ultra low melt polyester EA toners.

The present disclosure provides processes for forming a polyester dispersion with fewer steps and reduced amounts of solvent and surfactant, thereby allowing for shorter distillation times, and resulting in a toner with lower gloss values. In embodiments, a toner of the present disclosure may include at least one polyester resin in an organic solvent; at least one phase inversion agent; at least one oil component; a neutralizing agent; de-ionized water; and one or more additional ingredients of a toner composition.

In embodiments, a process of the present disclosure may include contacting at least one polyester resin possessing acid groups with an organic solvent to form a resin mixture; adding a phase inversion agent to the resin mixture; adding an oil component to the resin mixture; heating the resin mixture to a desired temperature; neutralizing the resin mixture with a neutralizing agent; and introducing de-ionized water to the resin mixture to form a resin emulsion.

The present disclosure also provides processes for producing a polyester dispersion for use in making a toner. In embodiments, a process of the present disclosure includes contacting at least one polyester resin with an organic solvent and a phase inversion agent to form a mixture; adding an oil component to the mixture; heating the mixture to a desired temperature; mixing an aqueous solution of neutralizing agent with the mixture; adding de-ionized water to the mixture until phase inversion occurs to form a phase inversed mixture such that the oil component is incorporated in a hydrophobic core of latex particles formed in the phase inversed mixture; and removing the solvents from the phase inversed mixture.

In embodiments, the present disclosure also discloses a core-shell toner composition wherein the toner core includes a high molecular weight amorphous resin having the oil component, an optional low molecular weight amorphous resin and crystalline polyester resin; and a shell that includes a high molecular weight amorphous resin, optionally having the oil component, and an optional lower molecular weight amorphous resin.

### Resins

Any resin may be utilized in forming a latex emulsion of the present disclosure. In embodiments, the resins may be an amorphous resin, a crystalline resin, and/or a combination thereof. In further embodiments, the resin may be a polyester resin, including the resins described in U.S. Pat. Nos. 6,593,049 and 6,756,176, the disclosures of each of which are hereby incorporated by reference in their entirety. Suitable resins may also include a mixture of an amorphous polyester resin and a crystalline polyester resin as described in U.S. Pat. No. 6,830,860, the disclosure of which is hereby incorporated by reference in its entirety.

In embodiments, the resin may be a polyester resin formed by reacting a diol with a diacid in the presence of an optional catalyst. For forming a crystalline polyester, suitable organic diols include aliphatic dials with from about 2 to about 36 carbon atoms, such as 1,2-ethanediol, 1,3-propanediol, 1,4-butanediol, 1,5-pentanediol, 2,2-dimethylpropane-1,3-diol, 1,6-hexanediol, 1,7-heptanediol, 1,8-octanediol, 1,9-nonanediol, 1,10-decanediol, 1,12-dodecanediol and the like including their structural isomers. The aliphatic diol may be, for example, selected in an amount of from about 40 to about 60 mole percent, in embodiments from about 42 to about 55 mole percent, in embodiments from about 45 to about 53 mole percent, and a second diol can be selected in an amount of from about 0 to about 10 mole percent, in embodiments from about 1 to about 4 mole percent of the resin.

Examples of organic diacids or diesters including vinyl diacids or vinyl diesters selected for the preparation of the crystalline resins include oxalic acid, succinic acid, glutaric acid, adipic acid, suberic acid, azelaic acid, sebacic acid, fumaric acid, dimethyl fumarate, dimethyl itaconate, cis, 1,4-diacetoxy-2-butene, diethyl fumarate, diethyl maleate, phthalic acid, isophthalic acid, terephthalic acid, naphthalene-2,6-dicarboxylic acid, naphthalene-2,7-dicarboxylic acid, cyclohexane dicarboxylic acid, malonic acid and mesaconic acid, a diester or anhydride thereof. The organic diacid may be selected in an amount of, for example, in embodiments from about 40 to about 60 mole percent, in embodiments from about 42 to about 52 mole percent, in embodiments from about 45 to about 50 mole percent, and a second diacid can be selected in an amount of from about 0 to about 10 mole percent of the resin.

Examples of crystalline resins include polyesters, polyamides, polyimides, polyolefins, polyethylene, polybutylene, polyisobutyrate, ethylene-propylene copolymers, ethylene-vinyl acetate copolymers, polypropylene, mixtures thereof, and the like. Specific crystalline resins may be polyester based, such as poly(ethylene-adipate), poly(propylene-adipate), poly(butylene-adipate), poly(pentylene-adipate), poly(hexylene-adipate), poly(octylene-adipate), poly(ethylene-succinate), poly(propylene-succinate), poly(butylene-succinate), poly(pentylene-succinate), poly(hexylene-succinate), poly(octylene-succinate), poly(ethylene-sebacate), poly(propylene-sebacate), poly(butylene-sebacate), poly(pentylene-sebacate), poly(hexylene-sebacate), poly(octylene-sebacate), poly(decylene-sebacate), poly(decylene-decanoate), poly(ethylene-decanoate), poly(ethylene dodecanoate), poly(nonylene-sebacate), poly(nonylene-decanoate), copoly(ethylene-fumarate)-copoly(ethylene-sebacate), copoly(ethylene-fumarate)-copoly(ethylene-decanoate), copoly(ethylene-fumarate)-copoly(ethylene-dodecanoate), copoly(2,2-dimethylpropane-1,3-diol-decanoate)-copoly(nonylene-decanoate), poly(octylene-adipate). Examples of polyamides include poly(ethylene-adipamide), poly(propylene-adipamide), poly(butylenes-adipamide), poly(pentylene-adipamide), poly(hexylene-adipamide), poly(octylene-adipamide), poly(ethylene-succinimide), and poly(propylene-sebecamide). Examples of polyimides include poly(ethylene-adipimide), poly(propylene-adipimide), poly(butylene-adipimide), poly(pentylene-adipimide), poly(hexylene-adipimide), poly(octylene-adipimide), poly(ethylene-succinimide), poly(propylene-succinimide), and poly(butylene-succinimide).

The crystalline resin may be present, for example, in an amount of from about 1 to about 50 percent by weight of the toner components, in embodiments from about 5 to about 35 percent by weight of the toner components. The crystalline resin can possess various melting points of, for example, from about 30° C. to about 120° C., in embodiments from about 50° C. to about 90° C. The crystalline resin may have a number average molecular weight (Mₙ), as measured by gel permeation chromatography (GPC) of, for example, from about 1,000 to about 50,000, in embodiments from about 2,000 to about 25,000, and a weight average molecular weight (M_{w}) of, for example, from about 2,000 to about 100,000, in embodiments from about 3,000 to about 80,000, as determined by Gel Permeation Chromatography using polystyrene standards. The molecular weight distribution (M_{w}/Mₙ) of the crystalline resin may be, for example, from about 2 to about 6, in embodiments from about 3 to about 4.

Examples of diacids or diesters including vinyl diacids or vinyl diesters utilized for the preparation of amorphous polyesters include dicarboxylic acids or diesters such as terephthalic acid, phthalic acid, isophthalic acid, fumaric acid, trimellitic acid, dimethyl fumarate, dimethyl itaconate, cis, 1,4-diacetoxy-2-butene, diethyl fumarate, diethyl maleate, maleic acid, succinic acid, itaconic acid, succinic acid, succinic anhydride, dodecylsuccinic acid, dodecylsuccinic anhydride, glutaric acid, glutaric anhydride, adipic acid, pimelic acid, suberic acid, azelaic acid, dodecanediacid, dimethyl terephthalate, diethyl terephthalate, dimethylisophthalate, diethylisophthalate, dimethylphthalate, phthalic anhydride, diethylphthalate, dimethylsuccinate, dimethylfumarate, dimethylmaleate, dimethylglutarate, dimethyladipate, dimethyl dodecylsuccinate, and combinations thereof. The organic diacids or diesters may be present, for example, in an amount from about 40 to about 60 mole percent of the resin, in embodiments from about 42 to about 52 mole percent of the resin, in embodiments from about 45 to about 50 mole percent of the resin.

Examples of diols which may be utilized in generating the amorphous polyester include 1,2-propanediol, 1,3-propanediol, 1,2-butanediol, 1,3-butanediol, 1,4-butanediol, pentanediol, hexanediol, 2,2-dimethylpropanediol, 2,2,3-trimethylhexanediol, heptanediol, dodecanediol, bis(hydroxyethyl)-bisphenol A, bis(2-hydroxypropyl)-bisphenol A, 1,4-cyclohexanedimethanol, 1,3-cyclohexanedimethanol, xylenedimethanol, cyclohexanediol, diethylene glycol, bis(2-hydroxyethyl)oxide, dipropylene glycol, dibutylene, and combinations thereof. The amount of organic diols selected can vary, and may be present, for example, in an amount from about 40 to about 60 mole percent of the resin, in embodiments from about 42 to about 55 mole percent of the resin, in embodiments from about 45 to about 53 mole percent of the resin.

Polycondensation catalysts which may be utilized in forming either the crystalline or amorphous polyesters include tetraalkyl titanates, dialkyltin oxides such as dibutyltin oxide, tetraalkyltins such as dibutyltin dilaurate, and dialkyltin oxide hydroxides such as butyltin oxide hydroxide, aluminum alkoxides, alkyl zinc, dialkyl zinc, zinc oxide, stannous oxide, or combinations thereof. Such catalysts may be utilized in amounts of, for example, from about 0.01 mole percent to about 5 mole percent based on the starting diacid or diester used to generate the polyester resin.

In embodiments, as noted above, an unsaturated amorphous polyester resin may be utilized as a latex resin. Examples of such resins include those disclosed in U.S. Pat. No. 6,063,827, the disclosure of which is hereby incorporated by reference in its entirety. Exemplary unsaturated amorphous polyester resins include, but are not limited to, poly(propoxylated bisphenol co-fumarate), poly(ethoxylated bisphenol co-fumarate), poly(butyloxylated bisphenol co-fumarate), poly(co-propoxylated bisphenol co-ethoxylated bisphenol co-fumarate), poly(1,2-propylene fumarate), poly(propoxylated bisphenol co-maleate), poly(ethoxylated bisphenol co-maleate), poly(butyloxylated bisphenol co-maleate), poly(co-propoxylated bisphenol co-ethoxylated bisphenol co-maleate), poly(1,2-propylene maleate), poly(propoxylated bisphenol co-itaconate), poly(ethoxylated bisphenol co-itaconate), poly(butyloxylated bisphenol co-itaconate), poly(co-propoxylated bisphenol co-ethoxylated bisphenol co-itaconate), poly(1,2-propylene itaconate), and combinations thereof.

In embodiments, a suitable polyester resin may be an amorphous polyester such as a poly(propoxylated bisphenol A co-fumarate) resin having the following formula (I):

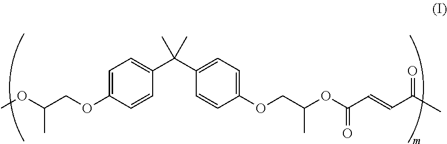

wherein m may be from about 5 to about 1000. Examples of such resins and processes for their production include those disclosed in U.S. Pat. No. 6,063,827, the disclosure of which is hereby incorporated by reference in its entirety.

An example of a linear propoxylated bisphenol A fumarate resin which may be utilized as a latex resin is available under the trade name SPARII from Resana S/A Industrias Quimicas, Sao Paulo Brazil. Other propoxylated bisphenol A fumarate resins that may be utilized and are commercially available include GTUF and FPESL-2 from Kao Corporation, Japan, and EM181635 from Reichhold, Research Triangle Park, N.C., and the like.

In embodiments, a suitable polyester resin may be a high molecular weight amorphous resin and/or low molecular weight amorphous resin. The high molecular weight amorphous resin may have a weight average molecular weight (Mw) of from about 20,000 to about 120,000, in embodiments from about 50,000 to about 100,000. The low molecular weight amorphous resin may have a weight average molecular weight of from about 2,000 to about 40,000, in embodiments from about 8,000 to about 30,000.

Suitable crystalline resins which may be utilized, optionally in combination with an amorphous resin as descried above, include those disclosed in U.S. Patent Application Publication No. 2006/0222991, the disclosure of which is hereby incorporated by reference in its entirety. In embodiments, a suitable crystalline resin may include a resin formed of ethylene glycol and a mixture of dodecanedioic acid and fumaric acid co-monomers with the following formula:

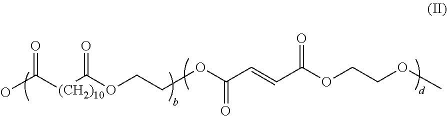

wherein b is from about 5 to about 2000 and d is from about 5 to about 2000.

For example, in embodiments, a poly(propoxylated bisphenol A co-fumarate) resin of formula I as described above may be combined with a crystalline resin of formula II to form a latex emulsion.

The amorphous resin may be present, for example, in an amount of from about 30 to about 90 percent by weight of the toner components, in embodiments from about 40 to about 80 percent by weight of the toner components. In embodiments, the amorphous resin or combination of amorphous resins utilized in the latex may have a glass transition temperature of from about 30° C. to about 80° C., in embodiments from about 35° C. to about 70° C. In further embodiments, the combined resins utilized in the latex may have a melt viscosity of from about 10 to about 1,000,000 Pa*S at about 130° C., in embodiments from about 50 to about 100,000 Pa*S.

One, two, or more resins may be used. In embodiments, where two or more resins are used, the resins may be in any suitable ratio (e.g., weight ratio) such as for instance of from about 1% (first resin)/99% (second resin) to about 99% (first resin)/1% (second resin), in embodiments from about 10% (first resin)/90% (second resin) to about 90% (first resin)/10% (second resin).

In embodiments, a suitable toner of the present disclosure may include 2 amorphous polyester resins and a crystalline polyester resin. The weight ratio of the three resins may be from about 29% first amorphous resin/69% second amorphous resin/2% crystalline resin, to about 60% first amorphous resin/20% second amorphous resin/20% crystalline resin.

In embodiments the resin may possess acid groups which, in embodiments, may be present at the terminal of the resin. Acid groups which may be present include carboxylic acid groups, and the like. The number of carboxylic acid groups may be controlled by adjusting the materials utilized to form the resin and reaction conditions.

In embodiments, the resin may be a polyester resin having an acid number from about 2 mg KOH/g of resin to about 200 mg KOH/g of resin, in embodiments from about 5 mg KOH/g of resin to about 50 mg KOH/g of resin. The acid containing resin may be dissolved in tetrahydrofuran solution. The acid number may be detected by titration with KOH/methanol solution containing phenolphthalein as the indicator. The acid number may then be calculated based on the equivalent amount of KOH/methanol required to neutralize all the acid groups on the resin identified as the end point of the titration.

### Solvent

Any suitable organic solvent may be used to dissolve the resin, for example, alcohols, esters, ethers, ketones, amines, the like, and combinations thereof, in an amount of, for example, from about 1 percent by weight to about 100 percent by weight resin, in embodiments, from about 10% to about 90%, in embodiments, from about 25% to about 85%.

In embodiments, suitable organic solvents include, for example, methanol, ethanol, propanol, isopropanol, butanol, ethyl acetate, methyl ethyl ketone, and the like, and combinations thereof. In embodiments, the organic solvent may be immiscible in water and may have a boiling point of from about 30° C. to about 120° C.

Any suitable organic solvent noted hereinabove may also be used as a phase or solvent inversion agent, and may be utilized in an amount of from about 1 percent by weight to about 25 percent by weight of the resin, in embodiments from about 5 percent by weight to about 20 percent by weight.

### Oil Component

In embodiments, an oil component may be added to the resin and solvent mixture. In embodiments, the phase inversion process may be utilized to incorporate the oil drops in the core of the latex resin. Any suitable oil or hydrocarbon component may be used in accordance with the present disclosure. In embodiments, suitable oil components may include both natural and/or synthetic oils, and hydrogenated and non-hydrogenated vegetable oils extracted from plants such as for example, jojoba oil, coconut oil, corn oil, cottonseed oil, olive oil, palm oil, palm kernel oil, rapeseed oil, almond oil, cashew oil, hazelnut oil, peanut oil, macadamia oil, mongongo oil, pine nut oil, pistachio oil, walnut oil, bottle gourd oil, buffalo gourd oil, pumpkin seed oil, watermelon seed oil, acai oil, blackcurrant seed oil, borage seed oil, evening primrose oil, carob pod oil, amaranth oil, apricot oil, apple seed oil, argan oil, artichoke oil, avocado oil, babassu oil, ben oil, borneo tallow nut oil, cape chestnut oil, cocoa butter, algaroba oil, cocklebur oil, poppyseed oil, cohune oil, dika oil, false flax oil, flax seed oil, soya bean oil, sunflower oil, grape seed oil, hemp oil, kapok seed oil, lallemantia oil, manila oil, meadowfoam seed oil, mustard oil, nutmeg butter, nutmeg oil, okra seed oil, papaya seed oil, perilla seed oil, pequi oil, pine nut oil, poppyseed oil, prune kernel oil, quinoa oil, ramtil oil, rice bran oil, royle oil, sacha inchi oil, camellia oil, thistle oil, tomato seed oil, wheat germ oil, whale oil, combinations thereof, and the like. Other suitable oil components may include paraffinic oils, naphthenic oils, and aromatic oils.

In embodiments, a natural-based, environmentally friendly jojoba oil (obtained from Simmondsia chinensis; commercially available from Sigma Aldrich) may be utilized as the oil component. The jojoba oil may be partially or completely hydrogenated (to form a waxy solid) and/or isomerized, and includes long chain esters having mainly 40-42 carbon atoms where the carboxy-esteric group is contained within the high lipophilic chain. The general structure of jojoba oil is:

(Z.Z)—CH₃(CH₂)₇CH═CH(CH₂)ₘCOO(CH₂)ₙCH═CH(CH₂)₇CH₃

### Jojoba Oil

m=7, 9, 11, 13 n=8, 10, 12, 14
% 11, 71, 14, 1 1, 44, 45, 9

In embodiments, synthetically made jojoba oil may be utilized and includes a mixture of esters of long chain monounsaturated acids and alcohols having 16-26 carbon atoms, e.g. esters of oleic acid and erucic acid with oleic alcohol or erucyl alcohol. Jojoba oil is stable toward oxygen and high temperatures due to its chemical structure, and is relatively less reactive as compared with regular olefins. Additionally, oxidation at the allylic position is very slow or not existent, so it is a good candidate as a release aid in toner formulations.

In embodiments, the oil component is present in an amount of from about 0.1% by weight to about 25% by weight of the total toner composition, in embodiments from about 1% by weight to about 15% by weight, in other embodiments from about 2% by weight to about 14% by weight.

In embodiments, the oil component includes oil droplets having a size of from about 0.5 nm to about 500 nm in diameter, in embodiments from about 10 nm to about 250 nm in diameter, in other embodiments from about 20 nm to about 60 nm in diameter.

### Neutralizing Agent

In embodiments, the resin may be mixed with a weak base or neutralizing agent to facilitate phase inversion of the water-in-oil emulsion (W/O) to an oil-in-water (O/W) emulsion. In embodiments, the neutralizing agent may be used to neutralize acid groups in the resins, so a neutralizing agent herein may also be referred to as a “basic neutralization agent.” Any suitable basic neutralization reagent may be used in accordance with the present disclosure. In embodiments, suitable basic neutralization agents may include both inorganic basic agents and organic basic agents. Suitable basic agents may include ammonia, ammonium hydroxide, potassium hydroxide, sodium hydroxide, sodium carbonate, sodium bicarbonate, lithium hydroxide, potassium carbonate, combinations thereof, and the like. Suitable basic agents may also include monocyclic compounds and polycyclic compounds having at least one nitrogen atom such as, for example, secondary amines, which include aziridines, azetidines, piperazines, piperidines, pyridines, bipyridines, terpyridines, dihydropyridines, morpholines, N-alkylmorpholines, 1,4-diazabicyclo[2.2.2]octanes, 1,8-diazabicycloundecanes, 1,8-diazabicycloundecenes, dimethylated pentylamines, trimethylated pentylamines, pyrimidines, pyrroles, pyrrolidines, pyrrolidinones, indoles, indolines, indanones, benzindazones, imidazoles, benzimidazoles, imidazolones, imidazolines, oxazoles, isoxazoles, oxazolines, oxadiazoles, thiadiazoles, carbazoles, quinolines, isoquinolines, naphthyridines, triazines, triazoles, tetrazoles, pyrazoles, pyrazolines, and combinations thereof. In embodiments, the monocyclic and polycyclic compounds may be unsubstituted or substituted at any carbon position on the ring.

In embodiments, a latex emulsion may be formed in accordance with the present disclosure which may also include water, in embodiments, de-ionized water (DIW), in amounts of from about 1% to about 100% of resin weight in embodiments, of from about 5% to about 95%, at temperatures that melt or soften the resin, of from about 0.5% to about 5%, in embodiments from about 0.7% to about 3%.

The basic agent may be utilized in an amount of from about 0.001% by weight to 50% by weight of the resin, in embodiments from about 0.01% by weight to about 25% by weight of the resin, in embodiments from about 0.1% by weight to 5% by weight of the resin. In embodiments, the neutralizing agent may be added in the form of an aqueous solution.

Utilizing the above basic neutralization agent in combination with a resin possessing acid groups, a neutralization ratio of from about 50% to about 300% may be achieved, in embodiments from about 70% to about 200%. In embodiments, the neutralization ratio may be calculated using the following equation:

Neutralization ratio in an equivalent amount of 10% NH₃/resin(g)/resin acid value/0.303*100.

As noted above, the basic neutralization agent may be added to a resin possessing acid groups. The addition of the basic neutralization agent may thus raise the pH of an emulsion including a resin possessing acid groups from about 5 to about 12, in embodiments, from about 6 to about 11. The neutralization of the acid groups may, in embodiments, enhance formation of the emulsion.

### Processing

As noted above, the present process includes mixing at least one resin at an elevated temperature, in the presence of an organic solvent. More than one resin may be utilized. The resin may be an amorphous resin, a crystalline resin, or a combination thereof. In embodiments, the resin may be an amorphous resin and the elevated temperature may be a temperature above the glass transition temperature of the resin. In other embodiments, the resin may be a crystalline resin and the elevated temperature may be a temperature above the melting point of the resin. In further embodiments, the resin may be a mixture of amorphous and crystalline resins and the temperature may be above the glass transition temperature of the mixture.

Thus, in embodiments, the process of making the emulsion may include contacting at least one resin with an organic solvent and a phase inversion agent, heating the resin mixture to an elevated temperature, stirring the mixture, and, while maintaining the temperature at the elevated temperature, adding an oil component to the resin mixture, adding a neutralizing agent to neutralize the acid groups of the resin, and adding water into the mixture until phase inversion occurs to form a phase inversed latex emulsion.

In the phase inversion process, the amorphous and/or crystalline polyester resin may be dissolved in a low boiling organic solvent, which solvent is immiscible in water, such as ethyl acetate, methyl ethyl ketone, or any other suitable solvent mentioned hereinabove, at a concentration of from about 1 percent by weight to about 75 percent by weight of resin in solvent, in embodiments from about 5% by weight to about 60% by weight. The resin mixture is then heated to a temperature of about 25° C. to about 90° C., in embodiments from about 30° C. to about 85° C. The heating need not be held at a constant temperature, but may be varied. For example, the heating may be slowly or incrementally increased during heating until a desired temperature is achieved.

While the temperature is maintained in the aforementioned range, the phase inversion agent may be added to the mixture. The phase inversion agent, such as an alcohol like isopropanol, or any other phase inversion agent noted hereinabove, in a concentration of from about 1 percent by weight to about 25 percent by weight of the resin, in embodiments from about 5% by weight to about 20% by weight, may be added to the heated resin mixture, followed by the addition of the oil component. The dissolved resin mixture with oil is neutralized with a neutralization agent described hereinabove, such as for example, an ammonia solution. Water may then be pumped into the system, until phase inversion occurs (forming an oil in water emulsion).

The aqueous alkaline composition and/or water may be metered into the heated mixture at least until phase inversion is achieved. In other embodiments, the aqueous alkaline composition may be metered into the heated mixture, followed by the addition of an aqueous solution, in embodiments deionized water, until phase inversion is achieved.

In embodiments, a continuous phase inversed emulsion may be formed. Phase inversion can be accomplished by continuing to add an aqueous alkaline solution or basic agent, and/or water compositions to create a phase inversed emulsion including a disperse phase including droplets possessing the molten ingredients of the resin composition, and a continuous phase including the water composition.

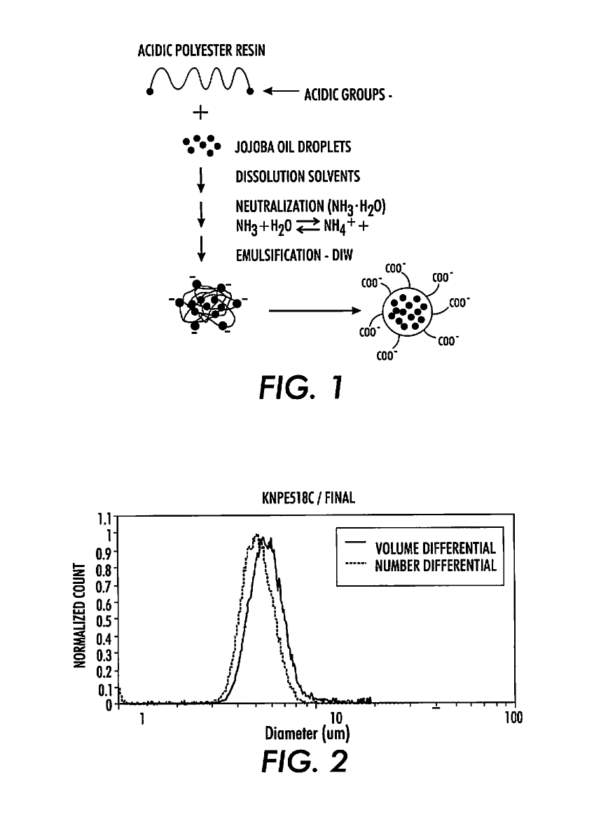

The chain ends of the polymer can reorient easily to the water/oil interface, thus driving the formation of and stabilizing the latex particles with the oil component trapped inside the core. Incorporation of the oil component in the hydrophobic core of the latex aggregates results in much easier processing into an EA toner. FIG. 1 illustrates a schematic process of incorporating the oil component into the latex resin in accordance with the present disclosure.

Mixing, including melt mixing, may be conducted in an extruder, i.e. a twin screw extruder, a kneader such as a Haake mixer, a batch reactor, or any other device capable of intimately mixing viscous materials to create near homogenous mixtures.

As noted above, in accordance with the present disclosure, a neutralizing agent may be added to the resin after it has been melt mixed. The addition of the neutralizing agent may be useful, in embodiments, where the resin utilized possesses acid groups. The neutralizing agent may neutralize the acidic groups of the resin, thereby enhancing the formation of the phase-inversed emulsion and formation of particles suitable for use in forming toner compositions.

Prior to addition, the neutralizing agent may be at any suitable temperature, including room temperature of from about 20° C. to about 25° C., or an elevated temperature, for example, the elevated temperature mentioned above.

In embodiments, the neutralizing agent may be added at a rate of from about 0.01% percent by weight to about 10 percent by weight every 10 minutes, in embodiments from about 0.5 percent by weight to about 5 percent by weight every 10 minutes, in other embodiments from about 1 percent by weight to about 4 percent by weight every 10 minutes. The rate of addition of the neutralizing agent need not be constant, but can be varied.

In embodiments, where the process further includes adding water after the addition of basic neutralization agent, the water may be metered into the mixture at a rate of about 0.01 percent by weight to about 10 percent by weight every 10 minutes, in embodiments from about 0.5 percent by weight to about 5 percent by weight every 10 minutes, in other embodiments from about 1 percent by weight to about 4 percent by weight every 10 minutes. The rate of water addition need not be constant, but can be varied.

While higher water temperatures may accelerate the dissolution process, latexes can be formed at temperatures as low as room temperature. In other embodiments, water temperatures may be from about 40° C. to about 110° C., in embodiments, from about 50° C. to about 100° C.

Contact between the water and the resin mixture may be achieved in any suitable manner, such as in a vessel or continuous conduit, such as a packed bed. In embodiments, an extruder or batch process may be utilized. In embodiments, as the resin mixture travels down the extruder, water may be added at an injection port. In embodiments, the port may inject preheated de-ionized water into the extruder at rates of from about 1.0 ml/minute to about 1000 ml/minute, in embodiments, of from about 5 ml/minute to about 500 ml/minute.

Stirring, although not necessary, may be utilized to enhance formation of the latex. Any suitable stirring device may be utilized. In embodiments, the stirring may be at from about 10 revolutions per minute (rpm) to about 5,000 rpm, in embodiments from about 20 rpm to about 2,000 rpm, in other embodiments from about 50 rpm to about 1,000 rpm. The stirring need not be at a constant speed, but may be varied. For example, as the heating of the mixture becomes more uniform, the stirring rate may be increased. In embodiments, a homogenizer (that is, a high shear device), may be utilized to form the phase inversed emulsion, but in other embodiments, the process of the present disclosure may take place without the use of a homogenizer. Where utilized, a homogenizer may operate at a rate of from about 3,000 rpm to about 10,000 rpm.

Although the point of phase inversion may vary depending on the components of the emulsion, the temperature of heating, the stirring speed, and the like, phase inversion may occur when basic neutralization agent and water has been added so that the resulting resin is present in an amount from about 5 percent by weight to about 70 percent by weight by weight of the emulsion, in embodiments from about 20 percent by weight to about 65 percent by weight by weight of the emulsion, in other embodiments from about 30 percent by weight to about 60 percent by weight by weight of the emulsion.

In embodiments, distillation with stirring of the organic solvent is performed to provide resin emulsion particles with an average diameter size of, for example, in embodiments from about 50 nm to about 250 nm, in other embodiments from about 120 to about 180 nanometers.

At phase inversion, the resin particles become emulsified and dispersed within the aqueous phase. That is, an oil-in-water emulsion of the resin particles in the aqueous phase is formed. Phase inversion may be confirmed by, for example, measuring via any of the techniques within the purview of those skilled in the art.

Phase inversion may permit formation of the emulsion at temperatures avoiding premature crosslinking of the resin of the emulsion.

In embodiments, the preparation of polyester emulsions of the present disclosure may include dissolution of at least one resin in at least one organic solvent, heating the mixture to an elevated temperature, neutralization using a neutralizing agent, its inversion through mixing with a solvent inversion agent and water, introducing an oil component in the resin mixture and finally distillation of the solvent from the emulsion. This process offers several advantages over current solvent-based processes for the formation of emulsions both at the laboratory and industrial scale.

Following phase inversion, additional water and/or aqueous alkaline solution may optionally be added to dilute the phase inversed emulsion, although this is not required. Following phase inversion, the phase inversed emulsion may be cooled to room temperature, for example from about 20° C. to about 25° C.

The process of the present disclosure, using PIE for the production of polyester latex emulsions, permits high throughput experimental screening, high throughput production rates, eliminates or minimizes wasted product, greatly reduces time to market for latex production, and produces latexes with reduced document offset damage and lower gloss. Additionally, toners produced in accordance with the present disclosure having such latexes have a better release from the fuser roll compared with conventional toners.

In accordance with the present disclosure, it has been found that the processes herein may produce emulsified resin particles that retain the same molecular weight properties of the starting resin, including equivalent charging and fusing performance.

Reducing the amount of solvent and surfactant used may produce polyester emulsions having a high product yield. Accordingly, a clean polyester dispersion with less residual solvents is produced.

The emulsified resin particles in the aqueous medium may have a submicron size, for example of about 1 μm or less, in embodiments about 500 nm or less, such as from about 10 nm to about 500 nm, in embodiments from about 50 nm to about 400 nm, in other embodiments from about 100 nm to about 300 nm, in some embodiments about 200 nm. Adjustments in particle size can be made by modifying the ratio of water to resin flow rates, the neutralization ratio, solvent concentration, and solvent composition.

The solids concentration of the latex may be controlled by the ratio of the resin mixture to the water.

The particle size distribution of latex particles of the present disclosure may be from about 30 nm to about 400 nm, in embodiments from about 125 nm to about 300 nm.

The latex emulsions of the present disclosure may be utilized to produce particle sizes that are suitable for emulsion aggregation processes, using a combination of crystalline and amorphous polyester resins.

### Toner

The emulsion thus formed as described above may be utilized to form toner compositions by any method within the purview of those skilled in the art. The latex emulsion may be contacted with a colorant, optionally in a dispersion, and other additives to form a toner by a suitable process, in embodiments, an emulsion aggregation and coalescence process.

In embodiments, the optional additional ingredients of a toner composition including colorant and other additives may be added before, during or after the melt mixing the resin to form the latex. The additional ingredients may be added before, during or after the formation of the latex emulsion, wherein the neutralized resin is contacted with water. In further embodiments, the colorant may be added before the addition of the oil component.

### Colorants

As the colorant to be added, various known suitable colorants, such as dyes, pigments, mixtures of dyes, mixtures of pigments, mixtures of dyes and pigments, and the like, may be included in the toner. In embodiments, the colorant may be included in the toner in an amount of, for example, about 0.1 to about 35% by weight of the toner, or from about 1 to about 15% by weight of the toner, or from about 3 to about 10% by weight of the toner.

As examples of suitable colorants, mention may be made of carbon black like REGAL 330® (Cabot), Carbon Black 5250 and 5750 (Columbian Chemicals), Sunsperse Carbon Black LHD 9303 (Sun Chemicals); magnetites, such as Mobay magnetites MO8029™, MO8060™; Columbian magnetites; MAPICO BLACKS™ and surface treated magnetites; Pfizer magnetites CB4799™, CB5300™, CB5600™, MCX6369™; Bayer magnetites, BAYFERROX 8600™, 8610™; Northern Pigments magnetites, NP-604™, NP608™; Magnox magnetites TMB-100™, or TMB-104™; and the like. As colored pigments, there can be selected cyan, magenta, yellow, red, green, brown, blue or mixtures thereof. Generally, cyan, magenta, or yellow pigments or dyes, or mixtures thereof, are used. The pigment or pigments are generally used as water based pigment dispersions.

In general, suitable colorants may include Paliogen Violet 5100 and 5890 (BASF), Normandy Magenta RD-2400 (Paul Uhlrich), Permanent Violet VT2645 (Paul Uhlrich), Heliogen Green L8730 (BASF), Argyle Green XP-111-S (Paul Uhlrich), Brilliant Green Toner GR 0991 (Paul Uhlrich), Lithol Scarlet D3700 (BASF), Toluidine Red (Aldrich), Scarlet for Thermoplast NSD PS PA (Ugine Kuhlmann of Canada), Lithol Rubine Toner (Paul Uhlrich), Lithol Scarlet 4440 (BASF), NBD 3700 (BASF), Bon Red C (Dominion Color), Royal Brilliant Red RD-8192 (Paul Uhlrich), Oracet Pink RF (Ciba Geigy), Paliogen Red 3340 and 3871K (BASF), Lithol Fast Scarlet L4300 (BASF), Heliogen Blue D6840, D7080, K7090, K6910 and L7020 (BASF), Sudan Blue OS (BASF), Neopen Blue FF4012 (BASF), PV Fast Blue B2G01 (American Hoechst), Irgalite Blue BCA (Ciba Geigy), Paliogen Blue 6470 (BASF), Sudan II, III and IV (Matheson, Coleman, Bell), Sudan Orange (Aldrich), Sudan Orange 220 (BASF), Paliogen Orange 3040 (BASF), Ortho Orange OR2673 (Paul Uhlrich), Paliogen Yellow 152 and 1560 (BASF), Lithol Fast Yellow 0991K (BASF), Paliotol Yellow 1840 (BASF), Novaperm Yellow FGL (Hoechst), Permanerit Yellow YE 0305 (Paul Uhlrich), Lumogen Yellow D0790 (BASF), Sunsperse Yellow YHD 6001 (Sun Chemicals), Suco-Gelb 1250 (BASF), Suco-Yellow D1355 (BASF), Suco Fast Yellow D1165, D1355 and D1351 (BASF), Hostaperm Pink E™ (Hoechst), Fanal Pink D4830 (BASF), Cinquasia Magenta™ (DuPont), Paliogen Black L9984 (BASF), Pigment Black K801 (BASF), Levanyl Black A-SF (Miles, Bayer), combinations of the foregoing, and the like.

Other suitable water based colorant dispersions include those commercially available from Clariant, for example, Hostafine Yellow GR, Hostafine Black T and Black TS, Hostafine Blue B2G, Hostafine Rubine F6B and magenta dry pigment such as Toner Magenta 6BVP2213 and Toner Magenta EO2 which may be dispersed in water and/or surfactant prior to use.

Specific examples of pigments include Sunsperse BHD 6011X (Blue 15 Type), Sunsperse BHD 9312X (Pigment Blue 15 74160), Sunsperse BHD 6000X (Pigment Blue 15:3 74160), Sunsperse GHD 9600X and GHD 6004X (Pigment Green 7 74260), Sunsperse QHD 6040X (Pigment Red 122 73915), Sunsperse RHD 9668X (Pigment Red 185 12516), Sunsperse RHD 9365X and 9504X (Pigment Red 57 15850:1, Sunsperse YHD 6005X (Pigment Yellow 83 21108), Flexiverse YFD 4249 (Pigment Yellow 17 21105), Sunsperse YHD 6020X and 6045X (Pigment Yellow 74 11741), Sunsperse YHD 600X and 9604X (Pigment Yellow 14 21095), Flexiverse LFD 4343 and LFD 9736 (Pigment Black 7 77226), Aquatone, combinations thereof, and the like, as water based pigment dispersions from Sun Chemicals, Heliogen Blue L6900™, D6840™, D7080™, D7020™, Pylam Oil Blue™, Pylam Oil Yellow™, Pigment Blue 1™ available from Paul Uhlich & Company, Inc., Pigment Violet 1™, Pigment Red 48™, Lemon Chrome Yellow DCC 1026™, E.D. Toluidine Red™ and Bon Red C™ available from Dominion Color Corporation, Ltd., Toronto, Ontario, Novaperm Yellow FGL™, and the like. Generally, colorants that can be selected are black, cyan, magenta, or yellow, and mixtures thereof. Examples of magentas are 2,9-dimethyl-substituted quinacridone and anthraquinone dye identified in the Color Index as CI-60710, CI Dispersed Red 15, diazo dye identified in the Color Index as CI-26050, CI Solvent Red 19, and the like. Illustrative examples of cyans include copper tetra(octadecyl sulfonamido) phthalocyanine, x-copper phthalocyanine pigment listed in the Color Index as CI-74160, CI Pigment Blue, Pigment Blue 15:3, and Anthrathrene Blue, identified in the Color Index as CI-69810, Special Blue X-2137, and the like. Illustrative examples of yellows are diarylide yellow 3,3-dichlorobenzidene acetoacetanilides, a monoazo pigment identified in the Color Index as CI 12700, CI Solvent Yellow 16, a nitrophenyl amine sulfonamide identified in the Color Index as Foron Yellow SE/GLN, CI Dispersed Yellow 33 2,5-dimethoxy-4-sulfonanilide phenylazo-4′-chloro-2,5-dimethoxy acetoacetanilide, and Permanent Yellow FGL.

In embodiments, the colorant may include a pigment, a dye, combinations thereof, carbon black, magnetite, black, cyan, magenta, yellow, red, green, blue, brown, combinations thereof, in an amount sufficient to impart the desired color to the toner. It is to be understood that other useful colorants will become readily apparent based on the present disclosures.

In embodiments, a pigment or colorant may be employed in an amount of from about 1% by weight to about 35% by weight of the toner particles on a solids basis, in other embodiments, from about 5% by weight to about 25% by weight.

### Toner Preparation

The toner particles may be prepared by any method within the purview of one skilled in the art. Although embodiments relating to toner particle production are described below with respect to emulsion aggregation processes, any suitable method of preparing toner particles may be used, including chemical processes, such as suspension and encapsulation processes disclosed in U.S. Pat. Nos. 5,290,654 and 5,302,486, the disclosures of each of which are hereby incorporated by reference in their entirety. In embodiments, toner compositions and toner particles may be prepared by aggregation and coalescence processes in which small-size resin particles are aggregated to the appropriate toner particle size and then coalesced to achieve the final toner particle shape and morphology.

In embodiments, toner compositions may be prepared by emulsion aggregation processes, such as a process that includes aggregating a mixture of an optional colorant and any other desired or required additives, and emulsions including the resins described above, and then coalescing the aggregate mixture. A mixture may be prepared by adding a colorant or other materials, which may also be optionally in a dispersion(s) including a surfactant, to the emulsion, which may be a mixture of two or more emulsions containing the resin. The pH of the resulting mixture may be adjusted by an acid such as, for example, acetic acid, nitric acid or the like. In embodiments, the pH of the mixture may be adjusted to from about 2 to about 5. Additionally, in embodiments, the mixture may be homogenized. If the mixture is homogenized, homogenization may be accomplished by mixing at about 600 to about 6,000 revolutions per minute. Homogenization may be accomplished by any suitable means, including, for example, an IKA ULTRA TURRAX T50 probe homogenizer.

Following the preparation of the above mixture, an aggregating agent may be added to the mixture. Any suitable aggregating agent may be utilized to form a toner. Suitable aggregating agents include, for example, aqueous solutions of a divalent cation or a multivalent cation material. The aggregating agent may be, for example, an inorganic cationic aggregating agent such as polyaluminum halides such as polyaluminum chloride (PAC), or the corresponding bromide, fluoride, or iodide, polyaluminum silicates such as polyaluminum sulfosilicate (PASS), and water soluble metal salts including aluminum chloride, aluminum nitrite, aluminum sulfate, potassium aluminum sulfate, calcium acetate, calcium chloride, calcium nitrite, calcium oxylate, calcium sulfate, magnesium acetate, magnesium nitrate, magnesium sulfate, zinc acetate, zinc nitrate, zinc sulfate, zinc chloride, zinc bromide, magnesium bromide, copper chloride, copper sulfate, and combinations thereof. In embodiments, the aggregating agent may be added to the mixture at a temperature that is below the glass transition temperature (Tg) of the resin.

Suitable examples of organic cationic aggregating agents include, for example, dialkyl benzenealkyl ammonium chloride, lauryl trimethyl ammonium chloride, alkylbenzyl methyl ammonium chloride, alkyl benzyl dimethyl ammonium bromide, benzalkonium chloride, cetyl pyridinium bromide, C₁₂, C₁₅, C₁₇ trimethyl ammonium bromides, halide salts of quaternized polyoxyethylalkylamines, dodecylbenzyl triethyl ammonium chloride, combinations thereof, and the like.

Other suitable aggregating agents also include, but are not limited to, tetraalkyl titinates, dialkyltin oxide, tetraalkyltin oxide hydroxide, dialkyltin oxide hydroxide, aluminum alkoxides, alkyl zinc, dialkyl zinc, zinc oxides, stannous oxide, dibutyltin oxide, dibutyltin oxide hydroxide, tetraalkyl tin, combinations thereof, and the like. Where the aggregating agent is a polyion aggregating agent, the agent may have any desired number of polyion atoms present. For example, in embodiments, suitable polyaluminum compounds have from about 2 to about 13, in other embodiments, from about 3 to about 8, aluminum ions present in the compound.

The aggregating agent may be added to the mixture utilized to form a toner in an amount of, for example, from about 0% to about 10% by weight, in embodiments from about 0.2% to about 8% by weight, in other embodiments from about 0.5% to about 5% by weight, of the resin in the mixture. This should provide a sufficient amount of agent for aggregation.

The particles may be permitted to aggregate until a predetermined desired particle size is obtained. A predetermined desired size refers to the desired particle size to be obtained as determined prior to formation, and the particle size being monitored during the growth process until such particle size is reached. Samples may be taken during the growth process and analyzed, for example with a Coulter Counter, for average particle size. The aggregation thus may proceed by maintaining the elevated temperature, or slowly raising the temperature to, for example, from about 40° C. to about 100° C., and holding the mixture at this temperature for a time of from about 0.5 hours to about 6 hours, in embodiments from about hour 1 to about 5 hours, while maintaining stirring, to provide the aggregated particles. Once the predetermined desired particle size is reached, then the growth process is halted.

The growth and shaping of the particles following addition of the aggregation agent may be accomplished under any suitable conditions. For example, the growth and shaping may be conducted under conditions in which aggregation occurs separate from coalescence. For separate aggregation and coalescence stages, the aggregation process may be conducted under shearing conditions at an elevated temperature, for example of from about 40° C. to about 90° C., in embodiments from about 45° C. to about 80° C., which may be below the glass transition temperature of the resin as discussed above.

Once the desired final size of the toner particles is achieved, the pH of the mixture may be adjusted with a base to a value of from about 3 to about 10, and in embodiments from about 5 to about 9. The adjustment of the pH may be utilized to freeze, that is to stop, toner growth. The base utilized to stop toner growth may include any suitable base such as, for example, alkali metal hydroxides such as, for example, sodium hydroxide, potassium hydroxide, ammonium hydroxide, combinations thereof, and the like. In embodiments, ethylene diamine tetraacetic acid (EDTA) may be added to help adjust the pH to the desired values noted above.

### Shell Resin

In embodiments, after aggregation, but prior to coalescence, a resin coating may be applied to the aggregated particles to form a shell thereover. In embodiments, the core may thus include a high molecular weight and/or low molecular weight amorphous resin and an oil component, and optionally a crystalline resin. Any resin described above may be utilized as the shell. In embodiments, a polyester amorphous resin latex as described above may be included in the shell. In embodiments, the polyester amorphous resin latex described above may be combined with a different resin and/or oil component, and then added to the particles as a resin coating to form a shell.

In embodiments, resins which may be utilized to form a shell include, but are not limited to, the amorphous resins described above. In embodiments, an amorphous resin which may be utilized to form a shell in accordance with the present disclosure includes a high molecular weight amorphous polyester, optionally in combination with a low molecular weight amorphous polyester described above. Multiple resins may be utilized in any suitable amounts. In embodiments, a first amorphous polyester resin, for example an amorphous resin of formula I above, may be present in an amount of from about 20 percent by weight to about 100 percent by weight of the total shell resin, in embodiments from about 30 percent by weight to about 90 percent by weight of the total shell resin. Thus, in embodiments, a second resin may be present in the shell resin in an amount of from about 0 percent by weight to about 80 percent by weight of the total shell resin, in embodiments from about 10 percent by weight to about 70 percent by weight of the shell resin.

The shell resin may be applied to the aggregated particles by any method within the purview of those skilled in the art. In embodiments, the resins utilized to form the shell may be in an emulsion described above. The emulsion possessing the resins, optionally with an oil component described above, may be combined with the aggregated particles described above so that the shell forms over the aggregated particles.

The formation of the shell over the aggregated particles may occur while heating to a temperature of from about 30° C. to about 80° C., in embodiments from about 35° C. to about 70° C. The formation of the shell may take place for a period of time of from about 5 minutes to about 10 hours, in embodiments from about 10 minutes to about 5 hours.

The shell may be present in an amount of from about 10 percent by weight to about 50 percent by weight of the toner particles, in embodiments from about 15 percent by weight to about 35 percent by weight of the toner particles.

### Coalescence

Following aggregation to the desired particle size and application of any optional shell, the particles may then be coalesced to the desired final shape, the coalescence being achieved by, for example, heating the mixture to a temperature of from about 45° C. to about 100° C., in embodiments from about 55° C. to about 99° C., which may be at or above the glass transition temperature of the resins utilized to form the toner particles, and/or reducing the stirring, for example to from about 100 rpm to about 1,000 rpm, in embodiments from about 200 rpm to about 800 rpm. Coalescence may be accomplished over a period of from about 0.01 to about 9 hours, in embodiments from about 0.1 to about 4 hours.

After aggregation and/or coalescence, the mixture may be cooled to room temperature, such as from about 20° C. to about 25° C. The cooling may be rapid or slow, as desired. A suitable cooling method may include introducing cold water to a jacket around the reactor. After cooling, the toner particles may be optionally washed with water, and then dried. Drying may be accomplished by any suitable method for drying including, for example, freeze-drying.

### Additives

In embodiments, the toner particles may also contain other optional additives, as desired or required. For example, the toner may include positive or negative charge control agents, for example in an amount of from about 0.1 to about 10% by weight of the toner, in embodiments from about 1 to about 3% by weight of the toner. Examples of suitable charge control agents include quaternary ammonium compounds inclusive of alkyl pyridinium halides; bisulfates; alkyl pyridinium compounds, including those disclosed in U.S. Pat. No. 4,298,672, the disclosure of which is hereby incorporated by reference in its entirety; organic sulfate and sulfonate compositions, including those disclosed in U.S. Pat. No. 4,338,390, the disclosure of which is hereby incorporated by reference in its entirety; cetyl pyridinium tetrafluoroborates; distearyl dimethyl ammonium methyl sulfate; aluminum salts such as BONTRON E84™ or E88™ (Orient Chemical Industries, Ltd.); combinations thereof, and the like.

There can also be blended with the toner particles external additive particles after formation including flow aid additives, which additives may be present on the surface of the toner particles. Examples of these additives include metal oxides such as titanium oxide, silicon oxide, aluminum oxides, cerium oxides, tin oxide, mixtures thereof, and the like; colloidal and amorphous silicas, such as AEROSIL®, metal salts and metal salts of fatty acids inclusive of zinc stearate, calcium stearate, or long chain alcohols such as UNILIN 700, and mixtures thereof.

In general, silica may be applied to the toner surface for toner flow, tribo enhancement, admix control, improved development and transfer stability, and higher toner blocking temperature. TiO₂ may be applied for improved relative humidity (RH) stability, tribo control and improved development and transfer stability. Zinc stearate, calcium stearate and/or magnesium stearate may optionally also be used as an external additive for providing lubricating properties, developer conductivity, tribo enhancement, enabling higher toner charge and charge stability by increasing the number of contacts between toner and carrier particles. In embodiments, a commercially available zinc stearate known as Zinc Stearate L, obtained from Ferro Corporation, may be used. The external surface additives may be used with or without a coating.

Each of these external additives may be present in an amount of from about 0.1% by weight to about 5% by weight of the toner, in embodiments of from about 0.25% by weight to about 3% by weight of the toner. In embodiments, the toners may include, for example, from about 0.1% by weight to about 5% by weight titania, from about 0.1% by weight to about 8% by weight silica, and from about 0.1% by weight to about 4% by weight zinc stearate.

Suitable additives include those disclosed in U.S. Pat. Nos. 3,590,000, 3,800,588, and 6,214,507, the disclosures of each of which are hereby incorporated by reference in their entirety.

The processes of the present disclosure eliminate the use of excess surfactant and solvents, thereby reducing costs, may take less time by eliminating the wax emulsion step, may lower the gloss value, and may result in a consistent toner product.

Optimization of the toner formulation with an oil component may help improve some of the fusing issues encountered, that is, lowered gloss and document offset damage. Addition of an oil component may help prevent samples sticking together and may help improve toner performance after fusing.

The following Examples are being submitted to illustrate embodiments of the present disclosure. These Examples are intended to be illustrative only and are not intended to limit the scope of the present disclosure. Also, parts and percentages are by weight unless otherwise indicated. As used herein, “room temperature” refers to a temperature of from about 20° C. to about 25° C.

### EXAMPLES

### Example 1

A phase inversion emulsification (PIE) process to produce a polyester resin with jojoba oil. About 190 grams of a linear, high molecular weight FXC56 amorphous polyester resin, having a molecular weight of about 85,000, about 139 grams of methyl ethyl ketone (MEK), about 28.5 grams of 2-Propanol (IPA), and about 20 grams of jojoba oil were added to a 1 liter glass kettle, heated to about 45° C., and allowed to dissolve with stirring at about 80 rpm for about 1 hour. Once dissolved, the temperature was reduced to about 42° C. and about 5.71 grams of a 10% by weight ammonium hydroxide aqueous solution was added to this resin solution and the combination was left to stir at about 120 rpm for about 10 minutes at a temperature of about 42° C. De-ionized water (DIW), at room temperature, was fed to the neutralized resin with a metering pump, over about a 2 hour period at a rate of about 4 grams/minute.

The mixture was then cooled to room temperature and screened through a 20 micron sieve. The resulting resin emulsion included about 27% solids by weight and had a volume average diameter of about 332 nanometers as measured with a NANOTRAC® particle size analyzer.

### Example 2

Toner containing jojoba oil and no wax. A cyan polyester EA toner was prepared in a 2 liter reactor (about 134.36 grams dry theoretical toner). About 137.1 grams of an amorphous polyester in an emulsion (about 36% solids), about 200.6 grams of the amorphous emulsion with jojoba oil formed from Example 1, about 41 grams of a crystalline polyester in an emulsion (about 35% solids), about 1.01 grams of an anionic surfactant (commercially available from Dow Chemical), and about 58.2 grams of a Pigment Cyan 15:3 Dispersion were mixed together. While homogenizing the mixture at a speed of about 3000 to about 4000 rpm, an aluminum sulfate solution, including about 2.96 grams aluminum sulfate with about 36.6 grams of DIW was added over about a 5 minute period. The slurry was then transferred to a 2 liter Buchi reactor where the temperature was heated to begin aggregating at a batch temperature of about 43° C. During aggregation, particle size measurements were taken and run in a Multisizer Coulter counter.

Once the targeted particle size of about 4.5 microns was obtained, the amorphous emulsions described above and from Example 1 were added to the reactor to form a shell over the particles and the reactor was further heated to achieve the final targeted particle size. The slurry was then pH adjusted to about 7.8 utilizing sodium hydroxide (NaOH) and a chelating agent, tetrasodium ethylenediaminetetraacetate (VERSENE-100, commercially available from Dow Chemical Company) was added. The process proceeded with the reactor temperature (Tr) being increased to about 85° C. while maintaining a pH of greater than or equal to about 7.5 until Tr was about 80° C.

Once the temperature reached 85° C., the pH of the toner slurry was adjusted to about 7 with a sodium acetate-acetic acid buffer having a ph of about 5.7. The toner slurry was coalesced until the particles achieved the target circularity of greater than or equal to about 0.970 (about 40 minutes). Once coalesced, the toner slurry was cooled. The final toner particle volume average diameter (D50), volume average particle size distribution index (GSDv), number average particle size distribution index (GSDn), and circularity were measured using a Coulter counter and were about 5.55, 1.21, 1.21 and 0.978, respectively. The amount of jojoba oil in the particle was calculated to be about 4.6% by weight. The results are shown in FIG. 2.

### Example 3

Toner containing no wax and no oil. A cyan polyester EA toner was prepared as in Example 2 with a ratio of about 92:8 amorphous to crystalline resin. The amorphous resin emulsion included about a 50:50 ratio of high and low molecular weight amorphous polyester resins described in Example 2, of which about 50.6% was present in the core of the particle and 28% was present in the shell. The core also included about 6.8% of a crystalline polyester resin and about 5.5% Pigment Blue 15:3 pigment. The final toner particles were measured using a Coulter counter and the D50/GSDv/GSDn values measured were about 5.71/1.21/1.26, respectively.

### Example 4

Control baseline toner with wax. A cyan polyester EA toner was prepared as in Example 2 with a ratio of about 92:8 amorphous to crystalline resin. The amorphous resin emulsion included about a 50:50 ratio of high and low molecular weight amorphous resins described in Example 2, of which about 50.6% was present in the core of the particle and about 28% was in the shell. The core also included about 6.8% of a FXA006M crystalline resin, about 9% IGI wax (a polyethylene wax), and about 5.5% Pigment Blue 15:3 pigment. The final toner particles were measured using a Coulter counter and the D50/GSDv values measured were about 6.15/1.26, respectively.

### Gloss/Crease Fix

Unfused test images were made using a XEROX DC12 color copier/printer. Images were removed from the XEROX DC12 before the document passed through the fuser. Samples were fused onto Color Xpressions+ (90 gsm) using a XEROX DC252 fuser CRU mounted in a fusing fixture at about 220 mm/second. Fuser roll temperature were varied during the experiments so that gloss and crease area could be determined as a function of the fuser roll temperature. Print gloss was measured using a BYK Gardner 75° gloss meter. Toner adherence to the paper was determined by its crease fix minimum fusing temperature (MFT). The fused image was folded and an 860 grams roller was rolled across the fold after which the page was unfolded and wiped to remove the fractured toner from the sheet. This sheet was then scanned using an EPSON flatbed scanner and the area of toner which had been removed from the paper was determined by image analysis software such as the National Instruments IMAQ.

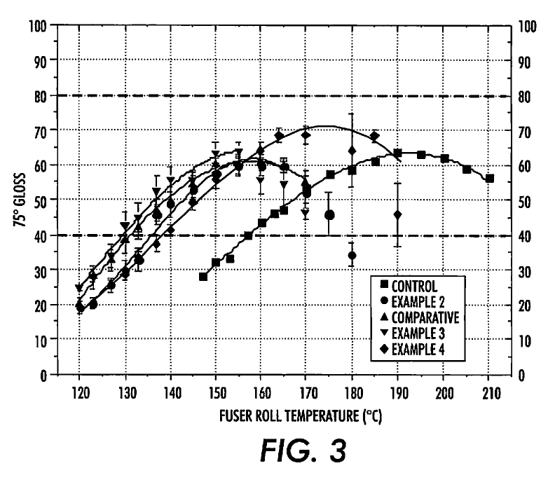

As illustrated in FIG. 3, the initial rise in gloss curve for the toner of Example 2 was in between the two earlier samples made without wax and the control toner made with wax. Peak gloss of Example 2 (4.6% Jojoba oil) at about 62 ggu was however less than the toner of Example 4, which had a peak gloss of about 71 ggu. The reduction in peak gloss for the sample made with oil was likely due to the sample starting to stick to the fuser roll creating image defects (gloss mottle, scratches). Severe document offset damage was found with the toner of Example 2, typical for toners made without wax. Wax on the surface of the print samples acted as a release agent and helped prevent samples from sticking together.

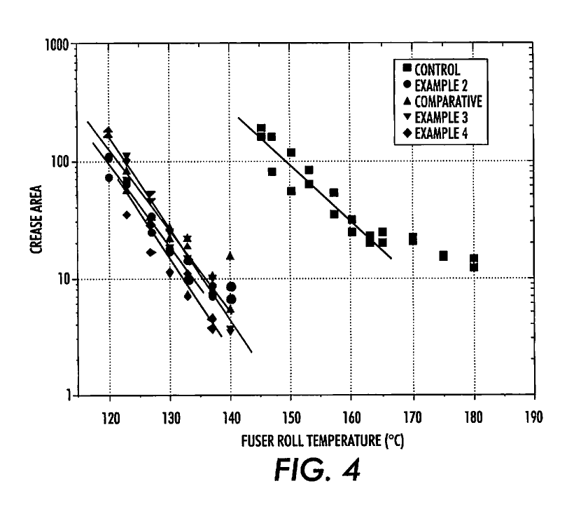

The toner of Example 2 (Jojoba oil/no wax) had a similar gloss and crease performance when compared to toner samples made with conventional phase inversion emulsion process. The toner of Example 2 reached 40 gloss units with the fuser roll temperature at about 135° C. and had an ultra-low crease fix MFT_{CA=85} of about 123° C., as illustrated in FIG. 4. The hot offset of the toner of Example 4 was at a higher temperature than the bench scale control toner. As can be noted from this data, the toner with Jojoba oil in Example 2 did not produce a toner that matched the fusing performance of a nominal toner made with wax, such as that in Example 4. Relative to toner Example 3 made without wax, the sample produced in Example 2 with about 4.6% Jojoba oil had a higher hot offset temperature (about 180° C. versus about 160° C.) and had better release from the fuser roll as indicated by the onset temperature of scratches on the print caused by the stripping blade (scratches visible at about 165° C. versus about 137° C.). Initial fusing experiments indicated some level of release was being provided by the oil in the toner and did not shift the crease fix MFT.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

What is claimed is:

1. A process comprising:
contacting at least one polyester resin with an organic solvent and a phase inversion agent to form a resin mixture;
adding at least one oil component to the resin mixture;
heating the resin mixture to a temperature of from about 25° C. to about 120° C.;
neutralizing the resin mixture with a neutralizing agent; and
introducing de-ionized water to the resin mixture to form a resin emulsion.

2. The process according to claim 1, wherein the polyester resin is selected from the group consisting of amorphous resins, crystalline resins, and combinations thereof.

3. The process according to claim 1, wherein the neutralizing agent is added in the form of an aqueous solution and is selected from the group consisting of ammonia, ammonium hydroxide, potassium hydroxide, sodium hydroxide, sodium carbonate, sodium bicarbonate, lithium hydroxide, potassium carbonate, organoamines, and combinations thereof, and raises the pH of the resin mixture to from about 5 to about 12.

4. The process according to claim 1, wherein the oil component is present in an amount of from about 0.1% by weight to about 25% by weight, includes oil droplets having a diameter of about 0.5 nm to about 500 nm and is selected from the group consisting of jojoba oil, mineral oil, silicone oil, coconut oil, corn oil, cottonseed oil, olive oil, palm oil, palm kernel oil, rapeseed oil, almond oil, cashew oil, hazelnut oil, peanut oil, macadamia oil, mongongo oil, pine nut oil, pistachio oil, walnut oil, bottle gourd oil, buffalo gourd oil, pumpkin seed oil, watermelon seed oil, acai oil, blackcurrant seed oil, borage seed oil, evening primrose oil, carob pod oil, amaranth oil, apricot oil, apple seed oil, argan oil, artichoke oil, avocado oil, babassu oil, ben oil, borneo tallow nut oil, cape chestnut oil, cocoa butter, algaroba oil, cocklebur oil, poppyseed oil, cohune oil, dika oil, false flax oil, flax seed oil, soya bean oil, sunflower oil, grape seed oil, hemp oil, kapok seed oil, lallemantia oil, manila oil, meadowfoam seed oil, mustard oil, nutmeg butter, nutmeg oil, okra seed oil, papaya seed oil, perilla seed oil, pequi oil, pine nut oil, p paraffinic oils, naphthenic oils, aromatic oils, poppyseed oil, prune kernel oil, quinoa oil, ramtil oil, rice bran oil, royle oil, sacha inchi oil, camellia oil, thistle oil, tomato seed oil, wheat germ oil and whale oil, paraffinic oils, naphthenic oils, aromatic oils, combinations thereof, and the like.

5. The process according to claim 1, wherein the resin mixture is heated to a temperature of from about 25° C. to about 90° C.

6. A process in accordance with claim 1, wherein the organic solvent is selected from the group consisting of an alcohol, ester, ether, ketone, an amine, and combinations thereof, in an amount of from about 1 percent by weight to about 100 percent by weight of the polyester resin, and wherein the phase inversion agent is an alcohol selected from the group consisting of methanol, ethanol, propanol, butanol, pentanol, ethylene glycol, propylene glycol, and combinations thereof, in an amount of from about 1 percent by weight to about 25 percent by weight of the polyester resin.

7. A process in accordance with claim 1, wherein the resin emulsion has a solids content of from about 5% to about 70%, and particles of the resin have an average diameter of from about 30 nanometers to about 100 nanometers.

8. A process comprising:
contacting at least one polyester resin possessing acid groups with an organic solvent and a phase inversion agent to form a mixture;
adding jojoba oil to the mixture;
heating the mixture to a temperature of from about 25° C. to about 120° C.;
adding an aqueous solution comprising a neutralizing agent to the mixture;
introducing de-ionized water to the mixture until phase inversion occurs to form a phase inversed mixture;
removing the solvents from the phase inversed mixture; and
recovering resin particles, wherein the oil component is incorporated in a hydrophobic core of the resin particles.

9. The process according to claim 8, wherein the polyester resin comprises a polyester resin selected from the group consisting of amorphous resins, crystalline resins, and combinations thereof, possessing acid groups.

10. The process according to claim 9, wherein the neutralizing agent is added in the form of an aqueous solution selected from the group consisting of ammonia, ammonium hydroxide, potassium hydroxide, sodium hydroxide, sodium carbonate, sodium bicarbonate, lithium hydroxide, potassium carbonate, organoamines, and combinations thereof, and raises the pH of the resin mixture to from about 5 to about 12.

11. The process according to claim 8, wherein the mixture is heated to a temperature of from about 25° C. to about 90° C., and wherein the step of removing the solvents occurs via vacuum distillation.

12. The process according to claim 8, wherein the oil component is present in an amount of from about 0.1% by weight to about 25% by weight and includes oil droplets having a size of about 0.5 nm to about 500 nm in diameter.

13. A process in accordance with claim 8, wherein the organic solvent is selected from the group consisting of an alcohol, ester, ether, ketone, amine, and combinations thereof, in an amount of from about 10 percent by weight to about 60 percent by weight of the polyester resin, and wherein the phase inversion agent is an alcohol selected from the group consisting of methanol, ethanol, propanol, butanol, pentanol, ethylene glycol, propylene glycol, and combinations thereof, in an amount of from about 1 percent by weight to about 25 percent by weight of the polyester resin.

14. A toner, comprising:
at least one polyester resin comprising resin particles;
at least one oil component; and
an optional colorant with optional toner additives,
wherein the at least one oil component forms a hydrophobic core of the resin particles.

15. The toner according to claim 14, wherein the oil component is present in an amount of from about 0.1% by weight to about 25% by weight, includes oil droplets of from about 0.5 nm to about 500 nm in diameter and is selected from the group consisting of jojoba oil, mineral oil, silicone oils, coconut oil, corn oil, cottonseed oil, olive oil, palm oil, palm kernel oil, rapeseed oil, almond oil, cashew oil, hazelnut oil, peanut oil, macadamia oil, mongongo oil, pine nut oil, pistachio oil, walnut oil, bottle gourd oil, buffalo gourd oil, pumpkin seed oil, watermelon seed oil, acai oil, blackcurrant seed oil, borage seed oil, evening primrose oil, carob pod oil, amaranth oil, apricot oil, apple seed oil, argan oil, artichoke oil, avocado oil, babassu oil, ben oil, borneo tallow nut oil, cape chestnut oil, cocoa butter, algaroba oil, cocklebur oil, poppyseed oil, cohune oil, dika oil, false flax oil, flax seed oil, soya bean oil, sunflower oil, grape seed oil, hemp oil, kapok seed oil, lallemantia oil, manila oil, meadowfoam seed oil, mustard oil, nutmeg butter, nutmeg oil, okra seed oil, papaya seed oil, perilla seed oil, pequi oil, pine nut oil, poppyseed oil, prune kernel oil, quinoa oil, ramtil oil, rice bran oil, royle oil, sacha inchi oil, camellia oil, thistle oil, tomato seed oil, wheat germ oil, whale oil, paraffinic oils, naphthenic oils, aromatic oils, combinations thereof, and the like.

16. The toner according to claim 14, wherein the polyester resin is selected from the group consisting of amorphous resins, crystalline resins, and combinations thereof.

17. The toner according to claim 14, wherein the colorant is selected from the group consisting of dyes, pigments, mixtures of dyes, mixtures of pigments, mixtures of dyes and pigments, and the like, and is present in amounts of from about 0.1% by weight to about 35% by weight of the toner.

18. The toner according to claim 14, wherein the additives are selected from the group consisting of titanium oxide, silicon oxide, aluminum oxides, cerium oxides, tin oxide, colloidal and amorphous silicas, zinc stearate, calcium stearate, alkyl pyridinium halides, bisulfates, alkyl pyridinium compounds, organic sulfates, organic sulfonates, cetyl pyridinium tetrafluoroborates, distearyl dimethyl ammonium methyl sulfate, aluminum salts, and combinations thereof.

19. The toner according to claim 14, wherein the toner has a particle size of from about 3 microns to about 12 microns.

20. The toner according to claim 14, wherein the toner has a gloss value of from about 30 ggu to about 90 ggu, and a hot offset temperature of from about 180° C. to about 210° C.
